(19) United States
(12) Patent Application Publication
(10) Pub. No.: US 2024/0274107 A1
(43) Pub. Date: Aug. 15, 2024

(54) SOUND-ABSORBING SHEET, METHOD FOR MANUFACTURING THE SAME, AND SPEAKER

(71) Applicant: AAC Technologies (Nanjing) Co., Ltd., Nanjing (CN)

(72) Inventors: Zhongyang Wang, Nanjing (CN); Hezhi Wang, Nanjing (CN); Jie Zhang, Nanjing (CN)

(21) Appl. No.: 18/327,016

(22) Filed: May 31, 2023

Related U.S. Application Data
(63) Continuation of application No. PCT/CN2023/081961, filed on Mar. 16, 2023.

(30) Foreign Application Priority Data
Feb. 15, 2023 (CN) 202310120373.1

(51) Int. Cl. G10K 11/168; C08J 9/00; C08J 9/08; C08J 9/28; C08J 9/36

(52) U.S. Cl. CPC G10K 11/168; C08J 9/0066; C08J 9/08; C08J 9/28; C08J 9/365; C08J 2309/08; C08J 2333/06; C08J 2375/04

(57) ABSTRACT

A sound-absorbing material, a manufacturing method thereof and a speaker are provided. The sound-absorbing sheet includes a sheet body and a bonding layer. The sheet body is prepared by coating and freeze-drying a slurry, and the slurry is obtained by mixing sound-absorbing powder, a binder, a thickening agent and a foaming agent with a solvent. The sheet body has thickness of 0.05 mm-2 mm; the sheet body has needle-like pores with a pore size of 1 μm-100 μm. The bonding layer is configured to fixedly install the sound-absorbing sheet. By needle-like pores, the sound-absorbing sheet has high sound absorption performance, and low damping performance. The sheet can be designed into different shapes and thicknesses for rear cavities of different speakers, so the application range is wide. Because of bonding layer, while aging risk of a structure in the speaker is lowered, the sound-absorbing sheet has higher strength.

### TECHNICAL FIELD

The present disclosure relates to an electro-acoustic conversion technology, and in particular to a sound-absorbing sheet, a method for manufacturing the sound-absorbing sheet and a speaker using the sound-absorbing sheet.

### BACKGROUND

With the continuous development of electronic devices, mobile terminals such as mobile phones tend to be lighter, thinner and flatter, and increasingly high requirements are imposed on audio quality. While the electronic devices become smaller, a space for a speaker unit is compressed. With a downsized rear cavity of the speaker, the audio quality will be affected. For a common approach in the field, a sound-absorbing particle material is added in the rear cavity of the speaker to enlarge the rear cavity virtually. Due to mutual collision and friction, the sound-absorbing particle material in the rear cavity is prone to peeling, crushing and so on in long-time use to affect the acoustic performance. Meanwhile, due to a static electricity caused by friction of sound-absorbing particles, the rear cavity is hardly filled up and its size cannot be utilized thoroughly. In another approach in the field, sound-absorbing powder is prepared into a bulk material to fill the rear cavity of the speaker. The bulk material avoids collision and friction of the particle material. By adding fibers and foams in the sound-absorbing bulk material, the strength and stability are further improved.

However, evidences show that the bulk material has significantly higher damping than the particle material. Compared with a same volume of the sound-absorbing particle material, the acoustic performance of the sound-absorbing bulk material is poor. After the sound-absorbing bulk material is added into the rear cavity of the speaker, there is still a gap with the rear cavity. In the long run, the surface of the bulk material will be morphologically changed for friction with the cavity, thereby affecting the performance.

Therefore, it is necessary to provide a novel sound-absorbing material to solve the above problems.

### SUMMARY

A technical problem to be solved by the present disclosure is to provide a sound-absorbing material with excellent sound absorption performance.

To solve the above-mentioned technical problem, in a first aspect, the present disclosure provides a sound-absorbing sheet. The sound-absorbing sheet is a sheet-like structure. The sound-absorbing sheet includes a sheet body and a bonding layer attached to one side of the sheet body; the sheet body is prepared by coating and freeze-drying a slurry, and the slurry is obtained by mixing sound-absorbing powder, a binder, a thickening agent and a foaming agent with a solvent; the sheet body has a thickness of 0.05 mm-2 mm; the sheet body has needle-like pores with a pore size of 1 μm-100 μm; and the bonding layer is configured to fixedly install the sound-absorbing sheet.

As an improvement, based on a weight of the sound-absorbing powder, the slurry includes 100 parts of the sound-absorbing powder, 4-10 parts of the binder, 1-5 parts of the thickening agent, 1-10 parts of the foaming agent, and 80-200 parts of the solvent.

As an improvement, the sound-absorbing powder is zeolite; and the zeolite is at least one selected from a group consisting of an MFI molecular sieve, a MEL molecular sieve and a FER molecular sieve, and has a particle size of smaller than 10 μm.

As an improvement, the binder is at least one selected from a group consisting of polyacrylate, styrene-butadiene rubber (SBR) latex, polystyrene acrylate, polystyrene acetate, polyurethane resin and polyethylene vinyl acetate (PEVA).

As an improvement, the thickening agent is at least one selected from a group consisting of sodium alginate, sodium polyacrylate, polyacrylamide, sodium hydroxypropyl methylcellulose (HPMC) and gelatin.

As an improvement, the foaming agent is at least one selected from a group consisting of hydrogen peroxide, ammonium bicarbonate and sodium bicarbonate.

As an improvement, the solvent is a mixed solution of an alcohol substance and water; and the alcohol substance accounts for 5-20% by mass of the mixed solution.

As an improvement, the alcohol substance is at least one selected from a group consisting of methanol, ethanol, propanol, n-butanol and tert-butanol.

As an improvement, the bonding layer has a thickness of 0.05 mm-0.5 mm.

In a second aspect, the present disclosure provides a method for manufacturing a sound-absorbing sheet. The method includes following steps:
mixing the sound-absorbing powder, the binder, the thickening agent and the foaming agent with the solvent to obtain the slurry; and performing ultrasonic dispersion to make the slurry homogeneous;
coating the slurry on a surface of the bonding layer to form the sheet body; and
freeze-drying the sheet body at a low temperature to remove the solvent, thereby obtaining the sound-absorbing sheet.

In a third aspect, the present disclosure provides a method for manufacturing a sound-absorbing sheet. The method includes following steps:
mixing the sound-absorbing powder, the binder, the thickening agent and the foaming agent with the solvent to obtain the slurry; and performing ultrasonic dispersion to make the slurry homogeneous;
coating the slurry on a surface of a release film to form the sheet body;
freeze-drying the sheet body at a low temperature to remove the solvent; and
attaching the bonding layer to a surface of the sheet body to obtain the sound-absorbing sheet.

In a fourth aspect, the present disclosure provides a speaker. The speaker includes a rear sound production cavity, and a sound-absorbing sheet mentioned in the first aspect. The sound-absorbing sheet is filled in the rear sound production cavity, and the sound-absorbing sheet is fixed in the rear sound production cavity through the bonding layer.

Compared with the related art, according to the sound-absorbing sheet provided by the present disclosure, the sound-absorbing sheet is a sheet-like structure. The sound-absorbing sheet includes a sheet body and a bonding layer attached to one side of the sheet body. The sheet body is prepared by mixing sound-absorbing powder, a binder, a thickening agent and a foaming agent with a solvent to obtain a slurry, and performing coating and freeze-drying. The sheet body has a thickness of 0.05 mm-2 mm. Needle-like pores with a pore size of 1 μm-100 μm are formed in the sheet body. The bonding layer is configured to fix the sound-absorbing sheet. By virtue of the needle-like pores, the sheet has high sound absorption performance, and approximately same low damping performance as the sound-absorbing particle material. The sheet can be designed into different shapes and thicknesses for rear cavities of different speakers, so the application range is wide. Because of the bonding layer attached to the surface of the sheet, while the aging risk of a structure in the speaker due to collision is lowered, the sound-absorbing sheet has a higher strength.

### BRIEF DESCRIPTION OF DRAWINGS

In order to more clearly illustrate the technical solutions in the embodiment of the present disclosure, the drawings used in the description of the embodiment will be briefly described below. It is obvious that the drawings in the following description are only some embodiments of the present disclosure. For those skilled in the art, other drawings can be obtained according to these drawings without creative efforts. In the drawings:

FIG. 1 is a structural schematic diagram of a sound-absorbing sheet according to an embodiment of the present disclosure; and

FIG. 2 is a scanning electron microscopy (SEM) image of a sound-absorbing sheet according to an embodiment of the present disclosure.

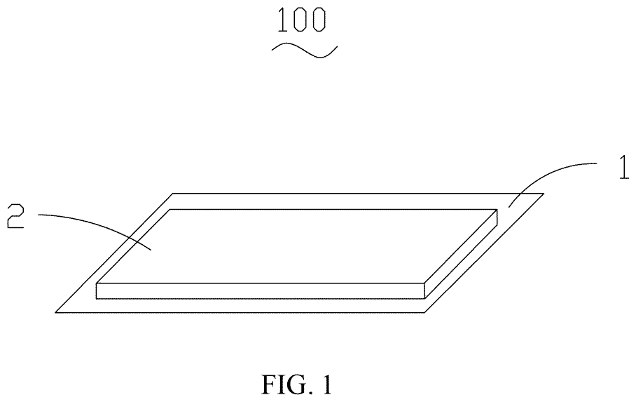

In FIG. 1: 1: bonding layer; and 2: sheet body.

### DETAILED DESCRIPTION OF EMBODIMENTS

The technical solutions of the embodiments of the present disclosure are clearly and completely described below with reference to the drawings. Apparently, the described embodiments are merely some rather than all of the embodiments of the present disclosure. All other embodiments obtained by those of ordinary skill in the art based on the embodiments of the present disclosure without creative efforts should fall within the protection scope of the present disclosure.

The present disclosure provides a sound-absorbing sheet. The sound-absorbing sheet is a sheet-like structure. The sound-absorbing sheet includes a sheet body and a bonding layer attached to one side of the sheet body. The sheet body is prepared by coating and freeze-drying a slurry, and the slurry is obtained by mixing sound-absorbing powder, a binder, a thickening agent and a foaming agent with a solvent. The sheet body has a thickness of 0.05 mm-2 mm. Needle-like pores with a pore size of 1 μm-100 μm are formed in the sheet body. The bonding layer is configured to fix the sound-absorbing sheet.

Exemplarily, referring to FIG. 1, FIG. 1 is a structural schematic diagram of a sound-absorbing sheet according to an embodiment of the present disclosure. The bonding layer 1 is attached to a surface of the sheet body 2. In an embodiment, the bonding layer 1 is attached through a double-sided adhesive tape. By tearing down an adhesive film of the double-sided adhesive tape, the sheet body 2 is attached to an inner surface of a rear cavity of a speaker. This improves acoustic performance of the speaker. The needle-like pores on the surface of the sheet body 2 may be formed in preparation, and may also be provided after the sheet body 2 is obtained. The needle-like pores may be arranged regularly, and may also be arranged irregularly. The needle-like pores may be designed according to an actual requirement. For example, for a non-planar rear cavity of the speaker, the needle-like pores may be arranged more densely at a front side of a sounder.

Optionally, based on a weight of the sound-absorbing powder, the slurry includes 100 parts of the sound-absorbing powder, 4-10 parts of the binder, 1-5 parts of the thickening agent, 1-10 parts of the foaming agent, and 80-200 parts of the solvent.

Optionally, the sound-absorbing powder is zeolite. The zeolite is at least one selected from a group consisting of an MFI molecular sieve, a MEL molecular sieve and a FER molecular sieve, and has a particle size of smaller than 10 μm.

Optionally, the binder is at least one selected from a group consisting of polyacrylate, SBR latex, polystyrene acrylate, polystyrene acetate, polyurethane resin and polyethylene vinyl acetate PEVA.

Optionally, the thickening agent is at least one selected from a group consisting of sodium alginate, sodium polyacrylate, polyacrylamide, sodium hydroxypropyl methylcellulose(HPMC) and gelatin.

Optionally, the foaming agent is at least one selected from a group consisting of hydrogen peroxide, ammonium bicarbonate and sodium bicarbonate.

Optionally, the solvent is a mixed solution of an alcohol substance and water. The alcohol substance accounts for 5%-20% by mass of the mixed solution.

Optionally, the alcohol substance is at least one selected from a group consisting of methanol, ethanol, propanol, n-butanol and tert-butanol.

Optionally, the bonding layer has a thickness of 0.05 mm-0.5 mm.

The present disclosure further provides a method for manufacturing a sound-absorbing sheet. The method includes the following steps.

The sound-absorbing powder, the binder, the thickening agent and the foaming agent are mixed with the solvent to obtain the slurry. Ultrasonic dispersion is performed to make the slurry homogeneous.

The slurry is coated on a surface of the bonding layer to form the sheet body.

The sheet body is freeze-dried at a low temperature to remove the solvent, thereby obtaining the sound-absorbing sheet.

The present disclosure further provides a method for manufacturing a sound-absorbing sheet. The method includes the following steps.

The sound-absorbing powder, the binder, the thickening agent and the foaming agent are mixed with the solvent to obtain the slurry. Ultrasonic dispersion is performed to make the slurry homogeneous.

The slurry is coated on a surface of a release film to form the sheet body.

The sheet body is freeze-dried at a low temperature to remove the solvent.

The bonding layer is attached to a surface of the sheet body to obtain the sound-absorbing sheet.

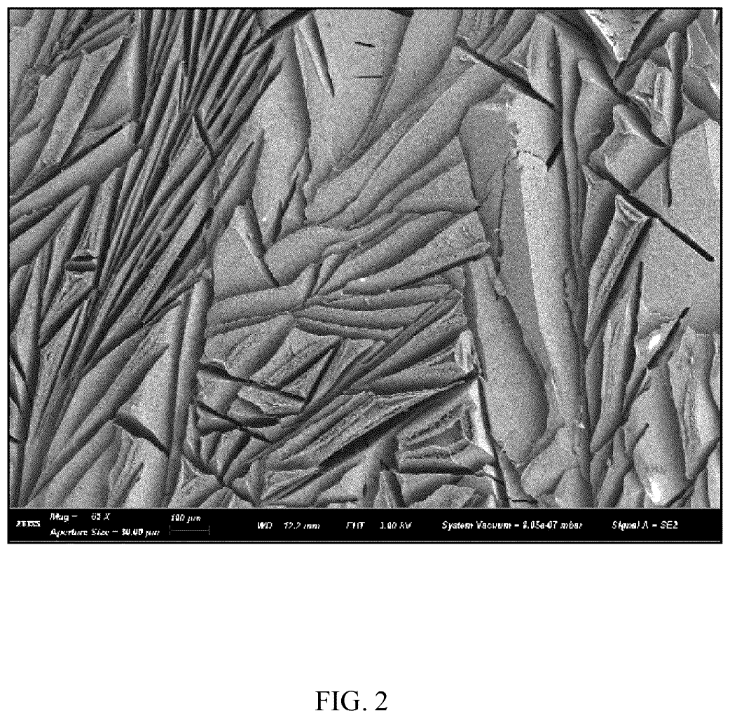

Exemplarily, referring to FIG. 2, FIG. 2 is an SEM image of a sound-absorbing sheet according to an embodiment of the present disclosure. For ease of understanding on influences of different components in the slurry on the sound absorption performance, following examples are provided to manufacture the sheet with optional materials based on the above manufacturing method.

### Example 1

50 g of zeolite powder, 2 g of polystyrene acrylate, 0.5 g of sodium alginate and 0.5 g of hydrogen peroxide were added to 40 g of a solvent. The solvent was an ethanol aqueous solution with a concentration of 5 wt %. A resulting mixture was ultrasonically stirred and dispersed to obtain 93 g of a slurry. The slurry was bonded on a double-sided adhesive tape through coating and freeze-drying to obtain the sound-absorbing sheet.

Specifically, the sound-absorbing sheet was obtained with the following two processes.

(1) The slurry was coated on the double-sided adhesive tape by a thickness of 0.4 mm. A resulting product was subjected to freezing crystallization at −20° C., and dried for 12 h in a vacuum freeze-drying oven to remove the solvent, thereby obtaining the sound-absorbing sheet.

(2) The slurry was coated a release film by a thickness of 0.4 mm. A resulting product was subjected to freezing crystallization −20° C., and dried for 12 h in a vacuum freeze-drying oven to remove the solvent. After the solvent was removed, a resulting sheet was bonded on the double-sided adhesive tape, thereby obtaining the sound-absorbing sheet.

### Example 2

50 g of zeolite powder, 5 g of SBR latex, 2.5 g of sodium HPMC and 2.5 g of sodium bicarbonate were added to 60 g of a solvent. The solvent was a tert-butanol aqueous solution with a concentration of 10 wt %. A resulting mixture was ultrasonically stirred and dispersed to obtain 120 g of a slurry. The slurry was bonded on a double-sided adhesive tape through coating and freeze-drying to obtain the sound-absorbing sheet. The coating and the freeze-drying were the same as those in Embodiment 1. A coating thickness was 1 mm.

### Example 3

50 g of zeolite powder, 3 g of polyurethane resin, 1 g of sodium polyacrylate and 5 g of hydrogen peroxide were added to 80 g of a solvent. The solvent was a n-butanol aqueous solution with a concentration of 15 wt %. A resulting mixture was ultrasonically stirred and dispersed to obtain 139 g of a slurry. The slurry was bonded on a double-sided adhesive tape through coating and freeze-drying to obtain the sound-absorbing sheet. The coating and the freeze-drying were the same as those in Embodiment 1. A coating thickness was 2 mm.

### Comparative Example 1

50 g of zeolite powder, 2 g of polystyrene acrylate, 0.5 g of sodium alginate and 0.5 g of hydrogen peroxide were added to 40 g of a solvent. The solvent was water. A resulting mixture was ultrasonically stirred and dispersed to obtain 93 g of a slurry. The slurry was bonded on a double-sided adhesive tape through coating and freeze-drying to obtain the sound-absorbing sheet. The coating and the freeze-drying were the same as those in Embodiment 1. A coating thickness was 0.4 mm.

### Comparative Example 2

50 g of zeolite powder, 5 g of SBR latex, 2.5 g of sodium HPMC and 2.5 g of sodium bicarbonate were added to 60 g of a solvent to obtain 120 g of a slurry. The solvent was water. The slurry was coated on a surface of a release film by a thickness of 1 mm. A resulting product was subjected to freezing crystallization at −20° C., and dried for 12 h in a vacuum freeze-drying oven to remove the solvent, thereby obtaining the sound-absorbing sheet.

In order to further describe the sound absorption performance, the sound-absorbing sheets in Examples 1-3 and Comparative Examples 1-2 are tested for comparison. For the sake of consistency of variables, the sound-absorbing sheets in different examples are processed as 20 mm in length, 12 mm in width and different thicknesses. The testing tool has a volume of 0.4 ml. Comparison results are as shown in Table 1.

TABLE 1
Test results for sound-absorbing sheets of different
examples in sound absorption performance

| | | F0 reduced | |
|---|---|---|---|
| Sample | Thickness/mm | value/Hz | Drop test |
| Example 1 | 0.4 | 72 | Intact |
| Example 2 | 1 | 114 | Intact |
| Example 3 | 2 | 173 | Intact |
| Comparative Example 1 | 0.4 | 54 | Intact |
| Comparative Example 2 | 1 | 86 | Crushed |

Evidences show that the sound-absorbing sheets in Examples 1-3 have better sound absorption performance than the sound-absorbing sheets in Comparative Examples 1-2. In Examples 1-3, the alcohol aqueous solvent is used as a freezing crystallization medium, and the needle-like pores are obtained by low-temperature vacuum drying. For a same thickness, the sound-absorbing sheet has superior sound absorption performance than a standard sample. In the comparative examples, the sample not attached to the double-sided adhesive tape is crushed in the drop test, while the other sample is intact. This indicates that the double-sided adhesive tape improves the strength of the sheet sample.

The present disclosure further provides a speaker. The speaker includes a rear sound production cavity, and the sound-absorbing sheet added in the rear sound production cavity. The sound-absorbing sheet is fixed in the rear sound production cavity through the bonding layer.

Compared with the related art, according to the sound-absorbing sheet provided by the present disclosure, the sound-absorbing sheet is a sheet-like structure. The sound-absorbing sheet includes a sheet body and a bonding layer attached to one side of the sheet body. The sheet body is prepared by mixing sound-absorbing powder, a binder, a thickening agent and a foaming agent with a solvent to obtain a slurry, and performing coating and freeze-drying. The sheet body has a thickness of 0.05-2 mm. Needle-like pores with a pore size of 1-100 μm are formed in the sheet body. The bonding layer is configured to fix the sound-absorbing sheet. By virtue of the needle-like pores, the sheet has high sound absorption performance, and approximately same low damping performance as the sound-absorbing particle material. The sheet can be designed into different shapes and thicknesses for rear cavities of different speakers, so the application range is wide. Because of the bonding layer attached to the surface of the sheet, while the aging risk of a structure in the speaker due to collision is lowered, the sound-absorbing sheet has a higher strength.

The above described are merely embodiments of the present disclosure. It should be noted here that those of ordinary skill in the art may make improvements without departing from the concept of the present disclosure, but such improvements should fall within the protection scope of the present disclosure.

What is claimed is:

1. A sound-absorbing sheet, wherein the sound-absorbing sheet is of a sheet-like structure; the sound-absorbing sheet comprises a sheet body and a bonding layer attached to one side of the sheet body; the sheet body is prepared by coating and freeze-drying a slurry, and the slurry is obtained by mixing sound-absorbing powder, a binder, a thickening agent and a foaming agent with a solvent; the sheet body has a thickness of 0.05 mm-2 mm; the sheet body has needle-like pores with a pore size of 1 μm-100 μm; and the bonding layer is configured to fixedly install the sound-absorbing sheet.

2. The sound-absorbing sheet as described in claim 1, wherein based on a weight of the sound-absorbing powder, the slurry comprises 100 parts of the sound-absorbing powder, 4-10 parts of the binder, 1-5 parts of the thickening agent, 1-10 parts of the foaming agent, and 80-200 parts of the solvent.

3. The sound-absorbing sheet as described in claim 1, wherein the sound-absorbing powder is zeolite; and the zeolite is at least one selected from a group consisting of an MFI molecular sieve, a MEL molecular sieve and a FER molecular sieve, and has a particle size of smaller than 10 μm.

4. The sound-absorbing sheet as described in claim 1, wherein the binder is at least one selected from a group consisting of polyacrylate, styrene-butadiene rubber (SBR) latex, polystyrene acrylate, polystyrene acetate, polyurethane resin and polyethylene vinyl acetate (PEVA).

5. The sound-absorbing sheet as described in claim 1, wherein the thickening agent is at least one selected from a group consisting of sodium alginate, sodium polyacrylate, polyacrylamide, sodium hydroxypropyl methylcellulose (HPMC) and gelatin.

6. The sound-absorbing sheet as described in claim 1, wherein the foaming agent is at least one selected from a group consisting of hydrogen peroxide, ammonium bicarbonate and sodium bicarbonate.

7. The sound-absorbing sheet as described in claim 1, wherein the solvent is a mixed solution of an alcohol substance and water; and the alcohol substance accounts for 5-20% by mass of the mixed solution.

8. The sound-absorbing sheet as described in claim 7, wherein the alcohol substance is at least one selected from a group consisting of methanol, ethanol, propanol, n-butanol and tert-butanol.

9. The sound-absorbing sheet as described in claim 1, wherein the bonding layer has a thickness of 0.05 mm-0.5 mm.

10. A method for manufacturing a sound-absorbing sheet, wherein the sound-absorbing sheet is of a sheet-like structure; the sound-absorbing sheet comprises a sheet body and a bonding layer attached to one side of the sheet body; the sheet body is prepared by coating and freeze-drying a slurry, and the slurry is obtained by mixing sound-absorbing powder, a binder, a thickening agent and a foaming agent with a solvent; the sheet body has a thickness of 0.05 mm-2 mm; the sheet body has needle-like pores with a pore size of 1 μm-100 μm; and the bonding layer is configured to fixedly install the sound-absorbing sheet; and
the method comprises following steps:
mixing the sound-absorbing powder, the binder, the thickening agent and the foaming agent with the solvent to obtain the slurry; and performing ultrasonic dispersion to make the slurry homogeneous;
coating the slurry on a surface of the bonding layer to form the sheet body; and
freeze-drying the sheet body at a low temperature to remove the solvent, thereby obtaining the sound-absorbing sheet.

11. A method for manufacturing a sound-absorbing sheet, wherein the sound-absorbing sheet is of a sheet-like structure; the sound-absorbing sheet comprises a sheet body and a bonding layer attached to one side of the sheet body; the sheet body is prepared by coating and freeze-drying a slurry, and the slurry is obtained by mixing sound-absorbing powder, a binder, a thickening agent and a foaming agent with a solvent; the sheet body has a thickness of 0.05 mm-2 mm; the sheet body has needle-like pores with a pore size of 1 μm-100 μm; and the bonding layer is configured to fixedly install the sound-absorbing sheet; and
the method comprises following steps:
mixing the sound-absorbing powder, the binder, the thickening agent and the foaming agent with the solvent to obtain the slurry; and performing ultrasonic dispersion to make the slurry homogeneous;
coating the slurry on a surface of a release film to form the sheet body;
freeze-drying the sheet body at a low temperature to remove the solvent; and
attaching the bonding layer to a surface of the sheet body to obtain the sound-absorbing sheet.

12. A speaker, comprising a rear sound production cavity, and a sound-absorbing sheet as described in claim 1, wherein the sound-absorbing sheet is filled in the rear sound production cavity, and the sound-absorbing sheet is fixed in the rear sound production cavity through the bonding layer.
